(19) United States
(12) Patent Application Publication
(10) Pub. No.: US 2021/0201696 A1
(43) Pub. Date: Jul. 1, 2021

(54) AUTOMATED SPEECH COACHING SYSTEMS AND METHODS

(71) Applicant: Intel Corporation, Santa Clara, CA (US)

(72) Inventors: Guillermo Perez, Sevilla (ES); Israel Perez Tudela, Alcalá del Río (ES); Manuel Castro, Tomares (ES)

(73) Assignee: Intel Corporation, Santa Clara, CA (US)

(21) Appl. No.: 16/623,814

(22) PCT Filed: Jul. 18, 2017
(86) PCT No.: PCT/US17/42650

§ 371 Date: Dec. 18, 2019

(51) Int. Cl. G09B 19/04; G09B 5/06; G10L 25/57; G10L 25/60; G10L 25/63

(52) U.S. Cl. CPC G09B 19/04; G09B 5/065; G10L 15/26; G10L 25/60; G10L 25/63; G10L 25/57

(57) ABSTRACT

The system may include data gathering circuitry to collect audio, video, and biometric data generated by a speaker during a presentation. All or a portion of the collected audio, video, and biometric data may be stored or otherwise retained on one or more storage devices. All or a portion of the collected audio, video, and biometric data may be forwarded to the presentation analysis circuitry. The presentation analysis circuitry detects at least one of: an audio presentation event; a video presentation event; or a biometric presentation event based at least in part on the collected audio, video, and biometric data received from the data gathering circuitry. The presentation analysis circuitry forwards the detected audio presentation event; a video presentation event; or a biometric presentation event to the presenter feedback circuitry. The presenter feedback circuitry generates feedback for presentation to the speaker.

### TECHNICAL FIELD

The present disclosure relates to technologies for providing audio, video, and physiological feedback to a speaker.

### BACKGROUND

Public speaking is a key talent. From teaching to selling, from high politics to small group meetings, being able to effectively convey ideas and convincingly present arguments is fundamental to achieving one's goals. Career advancement may be slowed or accelerated based, at least in part, on public speaking skills. Individuals engaged in many professions realize the importance of public speaking skills and often attempt to improve their skills to improve their promotability. However, improving public speaking ability is difficult because a large gap often exists between theoretical knowledge and practical proficiency. Just as with any other physical activity, training requires a human being paying attention at your performance and providing feedback and guidance. Individual coaching can be expensive and few have the time or financial resources to obtain such coaching. Furthermore, a single speaking coach may be insufficient to provide feedback on discourse processing, intonation, body movement, facial expression, and similar.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic diagram of an illustrative speech coaching system that includes processor circuitry, at least a portion of which provides data gathering circuitry, presentation analysis circuitry, and presenter feedback circuitry, in accordance with at least one embodiment described herein;

FIG. 2 is a schematic diagram of another illustrative speech coaching system that includes presentation analysis circuitry and presenter feedback circuitry, and dialogue circuitry, in accordance with at least one embodiment described herein;

FIG. 3 is an input/output (I/O) diagram of illustrative data gathering circuitry, in accordance with at least one embodiment described herein;

FIG. 4 is an input/output (I/O) diagram of illustrative presentation analysis circuitry, in accordance with at least one embodiment described herein;

FIG. 5 is an input/output (I/O) diagram of illustrative presenter feedback circuitry, in accordance with at least one embodiment described herein;

FIG. 6 is a block diagram of an illustrative system that includes an illustrative processor-based device capable of implementing the speech coaching systems and methods, in accordance with at least one embodiment described herein; and

FIG. 7 is a high-level flow diagram of an illustrative speech coaching method, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems, methods, and apparatuses disclosed herein provide automated speech coaching to individuals by analyzing the performance of the speaker and providing feedback on detected issues with speech, movement, gestures, and physiology. The systems, methods, and apparatuses disclosed herein provide general directions, guidance, and specific advice to improve their public speaking skills. The coaching system may include video and audio acquisition equipment that is used to autonomously identify unwanted, undesirable, or culturally inappropriate communication patterns, gestures, or traits of the speaker. Such patterns, gestures, and traits may arise from verbal disfluencies, inappropriate expressions, suboptimal body languages, distracting gestures, improper presentation styles, and similar.

The systems, methods, and apparatuses disclosed herein also include a dialogue management system trained to play the role of a public speaking expert. The systems and methods disclosed herein will collect audio, video, and/or biometric information of the system user, analyze the information to autonomously identify unwanted or undesired visual and/or audio patterns, and provide an output to the system user that not only identifies the unwanted or undesirable elements, but also provides corrective action to address the unwanted or undesirable elements. In at least some implementations, the systems, methods, and apparatuses disclosed herein may also make use of an anthropomorphic three-dimensional figure that impersonates the system user and provides visual feedback to the system user. Such an output is useful for not only making the communication speaker-coach more natural, but also provide examples, feedback, and recommendations regarding body language, gestures, facial expressions, etc.

A public speaking coaching system is provided. The system may include: processor circuitry; and at least one storage device that includes processor-readable instructions that, when executed by the processor circuitry, cause the processor circuitry to provide: data gathering circuitry to collect, during a presentation by a speaker, at least one of: audio data; video data; or biometric data; presentation analysis circuitry to detect an occurrence during the presentation by the speaker of at least one of: a defined audio event; a defined video event; or a defined biometric event; and presenter feedback circuitry to selectively provide feedback to the speaker, the feedback selected based upon at least one of: the defined audio event; the defined video event; or the defined biometric event.

A public speaking coaching method is provided. The method may include: collecting, by data gathering circuitry during a presentation by a speaker, at least one of: audio data; video data; or biometric data; detecting, by presentation analysis circuitry, an occurrence during the presentation by the speaker of at least one of: a defined audio event; a defined video event; or a defined biometric event; and selectively providing, by presenter feedback circuitry, feedback to the speaker, the feedback selected based upon at least one of: the defined audio event; the defined video event; or the defined biometric event.

A non-transitory computer readable medium is provided. The non-transitory computer readable medium may include instructions that when executed by processor circuitry, cause the processor circuitry to provide data gathering circuitry, presentation analysis circuitry, and presenter feedback circuitry. The processor circuitry to: collect, by the data gathering circuitry during a presentation by a speaker, at least one of: audio data; video data; or biometric data; detect, by the presentation analysis circuitry, an occurrence during the presentation by the speaker of at least one of: a defined audio event; a defined video event; or a defined biometric event; and selectively provide, by the presenter feedback circuitry, feedback to the speaker, the feedback selected based upon at least one of: the defined audio event; the defined video event; or the defined biometric event.

A public speaking coaching system is provided. The system may include: means for collecting at least one of: audio data; video data; or biometric data; means for detecting an occurrence during the presentation by the speaker of at least one of: a defined audio event; a defined video event; or a defined biometric event; and means for selectively providing feedback to the speaker, the feedback selected based upon at least one of: the defined audio event; the defined video event; or the defined biometric event.

As used herein the terms “top,” “bottom,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, the term “logically associated” when used in reference to a number of objects, systems, or elements, is intended to convey the existence of a relationship between the objects, systems, or elements such that access to one object, system, or element exposes the remaining objects, systems, or elements having a “logical association” with or to the accessed object, system, or element. An example “logical association” exists between relational databases where access to an element in a first database may provide information and/or data from one or more elements in a number of additional databases, each having an identified relationship to the accessed element. In another example, if “A” is logically associated with “B,” accessing “A” will expose or otherwise draw information and/or data from “B,” and vice-versa.

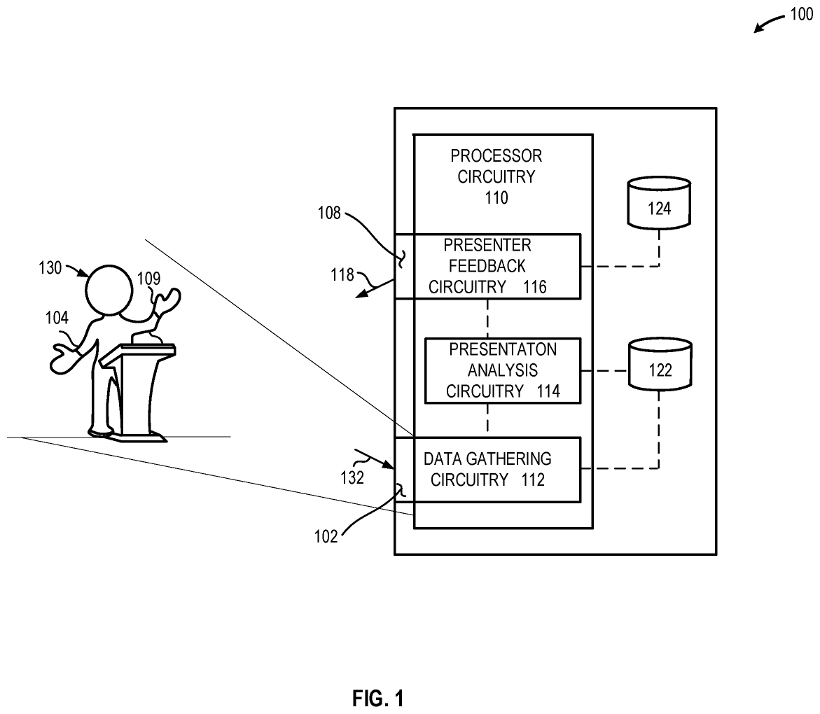

FIG. 1 is a schematic diagram of an illustrative speech coaching system 100 that includes processor circuitry 110, at least a portion of which provides data gathering circuitry 112, presentation analysis circuitry 114, and presenter feedback circuitry 116, in accordance with at least one embodiment described herein. As depicted in FIG. 1, the data gathering circuitry 112 collects information and/or data 132 associated with a speaker 130. In embodiments, the data gathering circuitry 112 may gather some at least some of: audio information and/or data; visual information and/or data; physiological information and/or data, and/or biometric information and/or data. The presentation analysis circuitry 114 analyzes the collected information and/or data to identify speaker characteristics, mannerisms, verbal disfluencies, actions, physical activities and similar verbal and non-verbal elements that either positively or negatively impact the ability of the speaker 130 to deliver a message to an audience. Once such elements are identified, the presenter feedback circuitry 116 may provide audio and/or visual feedback 118 to the speaker 130—such feedback 118 may include positive feedback to reinforce identified positive elements within the speaker's presentation and negative feedback/corrective actions to change or correct identified negative elements with the speaker's presentation.

The processor circuitry 110 may include any number and/or combination of electronic components, semiconductor devices, and/or logic elements capable of providing at least the data gathering circuitry 112, the presentation analysis circuitry 114 and the presenter feedback circuitry 116. In some implementations, the processor circuitry 110 may include one or more single- or multi-core processors or microprocessors. In some implementations, the processor circuitry 110 may include an application specific integrated circuit (ASIC); a system-on-a-chip (SoC), or similar device.

In embodiments, the data gathering circuitry 112 may be communicably coupled to one or more data acquisition devices 102. In some implementations, the data gathering circuitry 112 may be communicably coupled to one or more wearable data gathering devices 104 worn by the speaker 130. The wearable data gathering devices 104 may communicably couple to the data gathering circuitry 112 via one or more tethered connections (e.g., via a Universal Serial Bus or “USB” connection) or via one or more wireless connections (e.g., via a BLUETOOTH®, near field communication (“NFC”), Ethernet, or cellular connection. Example data gathering devices 102 may include, but are not limited to: one or more audio microphones and/or microphone arrays; one or more video cameras and/or camera arrays; one or more still image cameras or camera arrays; or combinations thereof. Example wearable data gathering devices 104 may include, but are not limited to: one or more biometric sensors, one or more physiological monitors, one or more wearable processor based devices; one or more microphones and/or microphone arrays; one or more video cameras and/or video camera arrays; or, combinations thereof. In some implementations, all or a portion of the wearable data gathering devices 104 may be disposed partially or completely in, on, or about a wearable device such as a smartwatch, or eyewear.

The data gathering devices 102 and the wearable data gathering devices 104 provide information and/or data 132 to the data gathering circuitry 112. In embodiments, some or all of the data gathering devices 102 and/or the wearable data gathering devices 104 may provide information and/or data 132 to the data gathering circuitry 112 on a continuous, intermittent, periodic, or aperiodic basis. In some implementations, the data gathering circuitry 112 may autonomously poll or otherwise call for data from one or more data gathering devices 102 and/or wearable data gathering devices 104 at increasing or decreasing data transfer rates and/or frequencies. For example, if information and/or data 132 collected by the data gathering circuitry 112 indicates a potential increasing stress level for the speaker 130, the data collection rate and/or frequency may be increased to provide enhanced information and/or data to the presentation analysis circuitry 114. In another example, if information and/or data 132 collected by the data gathering circuitry 112 indicates a potential increasing stress level during public questioning, the data gathering circuitry 112 may increase the data gathering rate and/or frequency during periods when public questions are presented to the speaker 132.

In some implementations, all or a portion of the information and/or data gathered by the data gathering circuitry 112 may be forwarded to the presentation analysis circuitry 114. In some implementations, all or a portion of the information and/or data gathered by the data gathering circuitry 112 may be stored or otherwise retained in one or more data structures, data stores, or databases disposed in, on, or about the storage device 122.

In embodiments, the presentation analysis circuitry 114 may analyze at least a portion of the information and/or data provided by the data gathering circuitry 112 on a continuous, intermittent, periodic, or aperiodic basis. For example, in one implementation the presentation analysis circuitry 114 may analyze the information and/or data provided by the data gathering circuitry 112 on a real-time or near real-time basis such that feedback is provided to the speaker 130 in a timely manner Such an arrangement beneficially permits the use of the speech coaching system 100 to provide near instant feedback, coaching, and guidance to a speaker 130.

In other embodiments, the presentation analysis circuitry 114 may retrieve from the storage device 122 at least a portion of the information and/or data stored or otherwise retained thereon by the data gathering circuitry 112. Such an arrangement permits a speaker 130 to “record” an entire presentation, review the presentation later, and receive feedback in a post-presentation setting more conducive to critical analysis of the feedback provided to the speaker.

The presentation analysis circuitry 114 may include any number and/or combination of systems and/or devices capable of receiving information and/or data from either or both the data gathering circuitry 112 and/or the storage device 122, analyzing the received information and/or data to identify speaker characteristics, mannerisms, verbal disfluencies, actions, physical activities and similar verbal and non-verbal elements that either positively or negatively impact the ability of the speaker 130 to deliver a message to an audience.

In embodiments, the presentation analysis circuitry 114 may analyze audio information and/or data to identify verbal disfluencies that are repeated during at least a portion of the presentation. In some implementations, the presentation analysis circuitry 114 may employ other voice and/or pattern recognition technology to identify strengths or weaknesses in the speaker's diction, volume, voice, or style. In some implementations, the presentation analysis circuitry 114 may analyze the content of the presentation and compare the content against cultural standards for a proposed target audience to identify words, symbols, and/or mannerisms that may be culturally inappropriate or offensive to the target audience. In some implementations, the presentation analysis circuitry 114 may compare the pronunciation of the content in at least a portion of the presentation against stored pronunciation information and/or data. In some implementations, the presentation analysis circuitry 114 may determine an appropriate mode or tone based on the content of the audio information and/or data provided by the speaker 130. Such information and/or data may be used by the presentation analysis circuitry 114 to provide the speaker with an indication of whether the tone or mode of the presentation is appropriate or consistent with the content of the presentation.

The presentation analysis circuitry 114 may analyze video information and/or data to identify posture, movement, and physical mannerisms that occur during at least a portion of the presentation. In some implementations, the presentation analysis circuitry 114 may employ pattern recognition technology to identify strengths or weaknesses in the speaker's physical posture, movement, and/or mannerisms. In some implementations, the presentation analysis circuitry 114 may convert at least a portion of the speaker 130 into a wireframe and compare the positioning and/or movement of the wireframe with acceptable or preferred positions or movement. For example, the presentation analysis circuitry 114 may compare the positioning of wireframe derived from the speaker 130 against one or more historical and/or culturally acceptable assertive positions that improve the effectiveness of the speaker's message on an audience. In some implementations, the presentation analysis circuitry 114 may acquire one or more images of the speaker's face and/or body—such images may then be used to facilitate the generation of one or more speaker avatar outputs by the presenter feedback circuitry 116. Movements identified by the presentation analysis circuitry 114 may include, but are not limited to, hand gestures, use of on-stage items such as podiums and lecterns for support, slumping, slouching, leaning, and other physiological elements that enhance or decrease the effectiveness of a presentation by the speaker 130. For example, the presentation analysis circuitry 114 may identify a slumping posture or leaning on a lectern or podium as inappropriate during an upbeat portion of the speaker's presentation as assessed by the audio portion of the presentation.

The presentation analysis circuitry 114 may include facial analysis circuitry capable of detecting a facial expressions indicative of a variety of emotions such as happiness, sadness, grief, sorrow, earnestness, and similar. In some implementations, the presentation analysis circuitry 114 may determine an appropriate facial expression, posture, and/or pose based on the content of the audio information and/or data provided by the speaker 130. Such information and/or data may be used by the presentation analysis circuitry 114 to provide the speaker with an indication of whether the facial expressions and/or physical pose or posture is appropriate and/or consistent with the content of the speaker's presentation. For example, the presentation analysis circuitry 114 may identify a facial expression such as a smile or laugh as inappropriate during a solemn portion of the speaker's presentation as assessed by the audio portion of the presentation.

The presentation analysis circuitry 114 may analyze biometric information and/or data to identify stressors or other elements of a presentation having either a positive or negative impact on the speaker 130. In some implementations, such biometric information and/or data may include, but is not limited to: pulse rate; skin conductivity; blood pressure; skin temperature; blood oxygen concentration; respiration rate; step counter (i.e., pedometer) or combinations thereof. Such information and/or data may assist the presentation analysis circuitry 114 in identifying portions of a presentation that are more stressful on the speaker 130. Such information may beneficially enable the presenter feedback circuitry 116 to provide feedback to the speaker 130 that is tailored to a particularly stressful portion of the presentation. Such information may also enable the presentation analysis circuitry 114 to analyze a speaker's breathing patterns and rate during the presentation to ensure the speaker is breathing at an acceptable rate and volume to maintain a desirable level of vocal and physical output over the course or duration of the presentation.

The presenter feedback circuitry 116 may include any number and/or combination of systems and/or devices capable of receiving information from the presentation analysis circuitry 114 and generating feedback for the speaker 130. In some implementations, one or more storage devices 124 may store or otherwise retain information and/or data associated with appropriate and/or effective presentation skills, video presentations of appropriate and/or effective presentation skills. In some implementations, the presenter feedback circuitry 116 may include an “expert” or similar system that includes information and/or data collected from a variety of sources. In embodiments, the presenter feedback circuitry 116 may generate a wireframe avatar of the speaker 130. Such a wireframe may be used to provide the speaker with a visual representation, avatar, or similar device that demonstrates a desirable or appropriate facial expression, physical pose or posture, etc. In some implementations, the presenter feedback circuitry 116 may provide feedback that is culturally appropriate or preferable. The presenter feedback circuitry 116 may provide audio feedback, video feedback or any combination thereof.

One or more output devices 108 may be communicably coupled to the presenter feedback circuitry 116 and may be used to provide either a real-time or delayed feedback output 118 to the speaker 130. The one or more output devices 108 may include, but are not limited to: one or more video output devices, one or more audio output devices, one or more haptic output devices, or combinations thereof. In some implementations, at least some of the output devices may be disposed in, on, or about one or more wearable devices 109, such as a smart watch or similar processor based wearable device.

In some implementations, some or all of the processor circuitry 110, the data gathering circuitry 112, the presentation analysis circuitry 114, the presenter feedback circuitry 116, and/or the storage devices 122, 124 may be disposed remote from the data gathering devices 102 and/or the one or more output devices 108. For example, in some embodiments, some or all of the processor circuitry 110, the data gathering circuitry 112, the presentation analysis circuitry 114, the presenter feedback circuitry 116, and/or the storage device 122, 124 may be provided as a remote cloud-based service and the data gathering devices 102 and/or the one or more output devices 108 may be disposed in a local device such as a laptop computer, a desktop computer, or a smartphone.

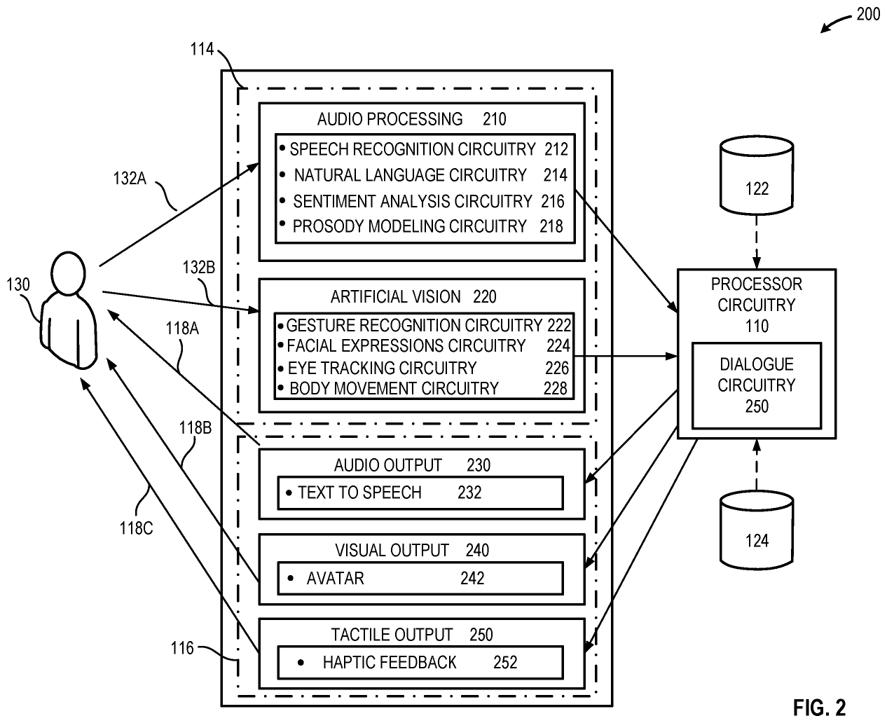

FIG. 2 is a schematic diagram of another illustrative speech coaching system 200 that includes presentation analysis circuitry 114 and presenter feedback circuitry 116, and dialogue circuitry 250, in accordance with at least one embodiment described herein. As depicted in FIG. 2, the presentation analysis circuitry 114 may include audio processing circuitry 210 and artificial vision circuitry 220. The presenter feedback circuitry 116 may include audio output 230 and video output 240.

The audio processing circuitry 210 includes speech recognition circuitry 212, natural language understanding circuitry 214, sentiment analysis circuitry 216, and prosody modeling circuitry 218. The audio processing circuitry 210 receives audio information and/or data from the data gathering circuitry 112 (e.g., audio capture devices and/or audio capture device arrays not shown in FIG. 2). The speech recognition circuitry 212 recognizes and translates the spoken language of the speaker into text. The language understanding circuitry 214 receives the text from the speech recognition circuitry 212 and, using semantic rules based on the spoken language of the speaker 130, detects patterns in the speaker's presentation. For example, the natural language understanding circuitry 214 may detect frequent repetitions in the speaker's presentation that may result in cumbersome listening for the audience (e.g., “you know,” “uh,” “um,” “I mean”). Other examples may include, but are not limited to, ungrammatical constructions, inappropriate expressions, sentence fragments, slang, and similar. The sentiment analysis circuitry 216 identifies the emotions (e.g., sadness, happiness, anger, and similar) of the speaker 130 based on text usage, tone, inflection, and similar vocal patterns and/or effects. The prosody modeling circuitry 218 classifies the speech based at least in part on the intonation of the speaker 130. In embodiments, the prosody modeling circuitry 218 may ensure the speaker 130 emphasizes the relevant portions of the presentation and assists the speaker 130 in avoiding a monotone presentation that may bore the audience.

The artificial vision circuitry 220 includes gesture recognition circuitry 222, facial expression recognition circuitry 224, eye tracking circuitry 226, and body movement circuitry 228. The artificial vision circuitry 220 receives video information and/or data from the data gathering circuitry 112 (e.g., video and/or still cameras and/or camera arrays—not shown in FIG. 2). The gesture recognition circuitry 222 tracks non-verbal communication and gestures made by the speaker's arms and hands. Such gestures may include pointing, clasping hands, clasping a lectern or podium, hand waving (e.g., “speaking with one's hands”), and similar. The presentation analysis circuitry 114 may determine the appropriateness or suitability of such gestures based on the content of the presentation, the tone of the presentation, cultural norms or practices, etc. The facial expression recognition circuitry 224 may identify emotions based on the expression of the speaker 130. For example, the facial expression recognition circuitry 224 may detect happiness, sadness, seriousness, sincerity, and similar emotions based on the facial expression of the speaker 130. The eye tracking circuitry 226 determines the point where the speaker is focused during the presentation. Such eye tracking information may beneficially determine whether the speaker is engaging visually with the audience during the presentation. The body movement circuitry 228 will track the speaker's posture and movement during the presentation, making sure the speaker is not too rigid nor too mobile over the course of the presentation.

In some implementations, the audio processing circuitry 210 may permit the speaker 130 to ask questions regarding the presentation. For example, the speaker 130 may ask the speech coaching system 200 for advice on a specific topic or solicit the speech coaching system 200 for general or specific feedback on one or more aspects of the presentation. In such an instance, the audio processing circuitry 210 may use the speech recognition circuitry 212 and the natural language understanding circuitry 214 to receive and interpret the request by the speaker 130. In some implementations, the speech coaching system 200 may also use at least one of the sentiment analysis circuitry 216, gesture recognition circuitry 222, and/or facial expression recognition circuitry 224 in receiving and interpreting the request by the speaker 130.

The presenter feedback circuitry 116 includes audio output circuitry 230, visual output circuitry 240, and tactile output circuitry 250. In implementations, the audio output circuitry 230 may include text-to-speech circuitry 232 that may be used to synthesize audio feedback 118A provided to the speaker 130. In implementations, the visual output circuitry 240 may include avatar generation circuitry 242 that may be used to generate an avatar representing the speaker 130. The avatar may then be used by the speech coaching system 200 to provide graphical feedback output 118B to the speaker 130. The tactile output circuitry 250 may include haptic feedback circuitry 252 capable of providing a tap or vibration sensible by the user 130. In some implementations, such haptic feedback circuitry 252 may be disposed, at least in part, in one or more wearable devices, such as a smartwatch capable of delivering one or more forms of haptic feedback to the user 130.

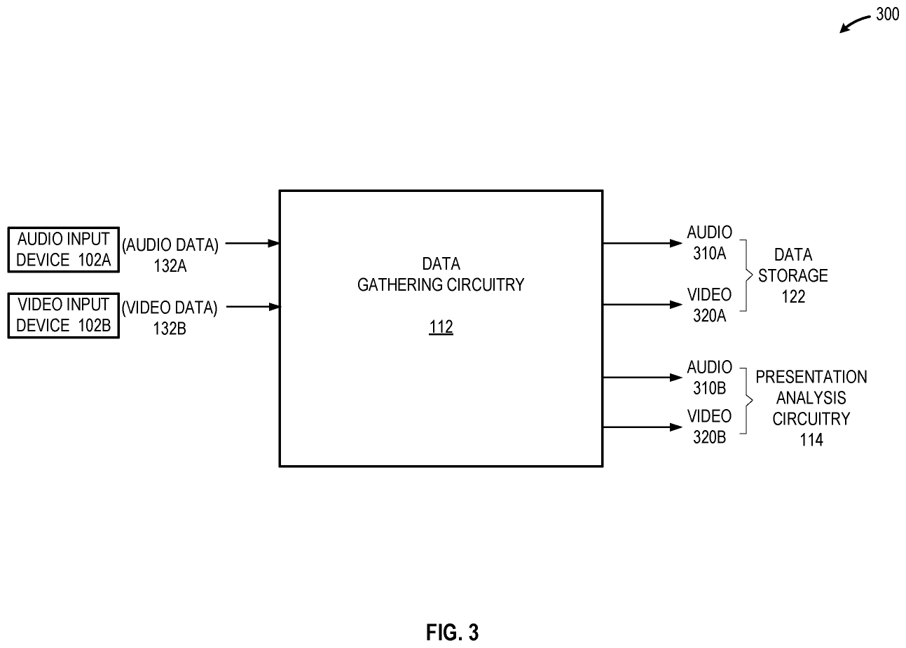

FIG. 3 is an input/output (I/O) diagram of illustrative data gathering circuitry 112, in accordance with at least one embodiment described herein. The data gathering circuitry 112 may receive audio information and/or data 132A provided or otherwise generated by one or more communicably coupled audio input devices 102A. The data gathering circuitry 112 may receive video information and/or data 132B provided or otherwise generated by one or more communicably coupled video input devices 102B. In some implementations, the one or more audio input devices 102A may provide the information and/or data to the data gathering circuitry 112 on a continuous, intermittent, periodic, or aperiodic basis. In some implementations, the one or more audio input devices 102A and/or the one or more video input devices 102B may be disposed local to the data gathering circuitry 112. In other implementations, the one or more audio input devices 102A and/or the one or more video input devices 102B may be disposed remote from the data gathering circuitry 112.

In embodiments, the data gathering circuitry 112 may output all or a portion of the received audio data and/or information 310A and/or all or a portion of the received video data and/or information 320A to the one or more data storage devices 122. In other embodiments, the data gathering circuitry 112 may output all or a portion of the received audio data and/or information 310B and/or all or a portion of the received video data and/or information 320B to the presentation analysis circuitry 114.

In some implementations, the data gathering circuitry 112 may pass all or a portion of the received audio information and/or data 132A and all or a portion of the received video information and/or data 132B unaltered to either the one or more storage devices 122 and/or the presentation analysis circuitry 114. In other implementations, the data gathering circuitry 112 may filter, alter, enhance, or otherwise modify all or a portion of the received audio information and/or data 132A and all or a portion of the received video information and/or data 132B prior to storing the information and/or data on the one or more storage devices 122 and/or passing the information and/or data to the presentation analysis circuitry 114.

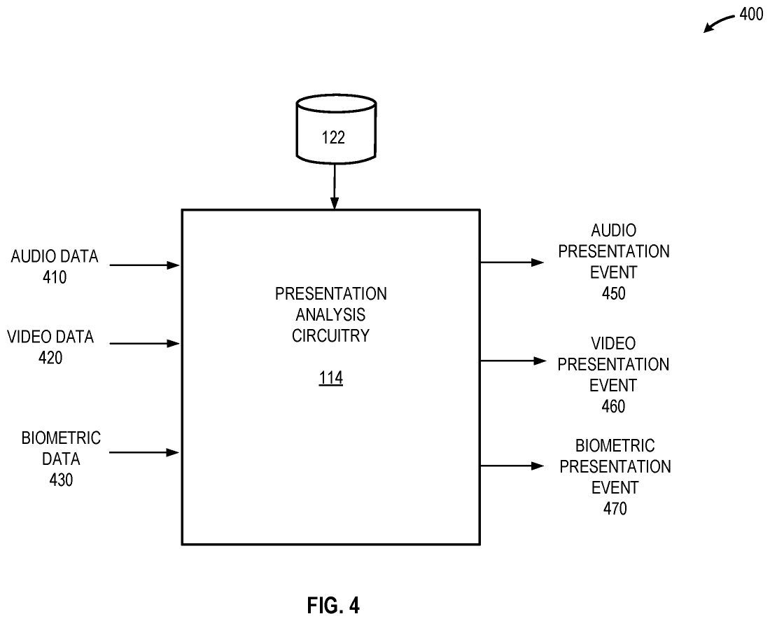

FIG. 4 is an input/output (I/O) diagram of illustrative presentation analysis circuitry 114, in accordance with at least one embodiment described herein. The presentation analysis circuitry 114 may receive audio data 410; video data 420; and biometric data 430 from the data gathering circuitry 112. In embodiments, the presentation analysis circuitry 114 analyzes the received audio data 410, video data 420, and biometric data 430 to detect the presence of one or more defined audio presentation events 450, video presentation events 460, and/or biometric presentation events 470, respectively. The presentation analysis circuitry 114 may analyze the received audio data 410, video data 420, and biometric data 430 either independently (i.e., each is analyzed separately) or collectively (i.e., some or all the audio, video, and/or biometric data are analyzed together to detect relationships between the audio, video, and/or biometric presentation events). The presentation analysis circuitry 114 then forwards information indicative of the detected audio presentation event 450, video presentation event 460, and/or biometric presentation event 470 to the presenter feedback circuitry 116.

In some implementations, the presentation analysis circuitry 114 may compare various segments, sections, or portions of received audio data 410 and/or video data 420 to detect recurring or repeated patterns such as repetitive words or phrases (e.g., “um,” “uh,” “you know,” “I mean”) or repetitive physical actions (e.g., hand gestures, swaying, rocking). In some implementations, the presentation analysis circuitry 114 may compare at least a portion of the received audio data 410, video data 420, and/or biometric data 430 to audio, video, and biometric data libraries saved in one or more data stores, data structures, or databases stored or otherwise retained on the one or more storage devices 122. Such libraries may be populated with audio, video, and biometric data selected based upon defined presentation strengths or weaknesses. Such libraries may be populated with audio, video, and biometric data selected based upon cultural norms or mores of the expected audience of the presentation. Such libraries may be a part or portion of an “expert” or similar system that is periodically, intermittently, or continuously updated to reflect current trends and technological developments. Such libraries may be tailored (i.e., contain audio, video, and biometric data relevant) to a technical field, technology, audience education level, or similar. Such libraries may be populated with audio, video, and biometric data selected based upon the expected sophistication and/or knowledge of the proposed audience (e.g., high school, undergraduate, graduate educated). Such libraries may be populated with one or more languages that are not native to the speaker 130 and may assist the speaker in forming the proper grammar and diction to provide the presentation in a non-native foreign language.

In embodiments, the presentation analysis circuitry 114 may determine whether the received audio data 410 includes data indicative of an audio presentation event 450. Such audio presentation events 450 may include, but are not limited to, repeated phrases, idioms, mispronunciations, verbal disfluencies, colloquialisms, and similar. Once such an audio presentation event 450 is detected, the presentation analysis circuitry 114 forwards information indicative of the audio presentation event 450 to the presenter feedback circuitry 116. Such information may include, but is not limited to, the type of audio presentation event 450, the elapsed presentation time at the start of the audio presentation event 450, and the duration of the audio presentation event 450. The presentation analysis circuitry 114 may also forward data indicative of the repeated phrases, idioms, mispronunciations, verbal disfluencies, or colloquialisms to the presenter feedback circuitry 116.

In some implementations, the presentation analysis circuitry 114 may detect data in the received audio data 410 indicative of one or more undesirable or culturally inappropriate words, expressions, colloquialisms, idioms, phrases or similar. The presentation analysis circuitry 114 may forward data indicative of such a culturally inappropriate audio presentation event to the presenter feedback circuitry 116. The presentation analysis circuitry 114 may also forward data indicative of the culturally inappropriate audio content to the presenter feedback circuitry 116.

In embodiments, the presentation analysis circuitry 114 may determine whether the received video data 420 includes data indicative of a video presentation event 460. Such video presentation events 460 may include, but are not limited to, an undesirable or inappropriate posture, gesture, position, movement, facial expression, eye position, hand position, or similar that detract, distract, or divert audience attention and/or reduce the effectiveness of the message conveyed by the speaker 130. Once such a video presentation event 460 is detected, presentation analysis circuitry 114 forwards information indicative of the video presentation event 460 to the presenter feedback circuitry 116. Such information may include, but is not limited to, the type of video presentation event 460, the elapsed presentation time at the start of the video presentation event 460, and the duration of the video presentation event 460. The presentation analysis circuitry 114 may also forward data indicative of the undesirable or inappropriate posture, gesture, position, movement, facial expression, eye position, or hand position to the presenter feedback circuitry 116.

For example, the presentation analysis circuitry 114 may detect the speaker is leaning on a lectern or podium while delivering the presentation. Such a posture would be considered inappropriate and, in response, the presentation analysis circuitry 114 forwards data indicative of the video presentation event 460 to the presenter feedback circuitry 116. In another example, the speaker may inadvertently make one or more hand gestures considered culturally offensive to at least a portion of the audience. Such gestures would be considered inappropriate and, in response, the presentation analysis circuitry 114 forwards data indicative of a video presentation event 460 to the presenter feedback circuitry 116.

In embodiments, the presentation analysis circuitry 114 may determine whether the received biometric data 430 includes data indicative of a biometric presentation event 470. Such biometric presentation events 470 may include, but are not limited to, an increase in the speaker's heart rate, an increase in the speaker's skin conductivity, an increase in the speaker's blood pressure, an increase/decrease in the speaker's body temperature, an increase/decrease in the speaker's respiration rate, an increase/decrease in the speaker's respiration volume, and similar. Such biometric changes may provide an early indication of those portions of the presentation that increase or decrease the stress level of the speaker 130. Responsive to detecting a biometric presentation event 470, the presentation analysis circuitry 114 forwards information indicative of the biometric presentation event 470 to the presenter feedback circuitry 116. Such information may include, but is not limited to, the type of biometric presentation event 470, the elapsed time at the start of the biometric presentation event 470, and the duration of the biometric presentation event 470. The presentation analysis circuitry 114 may also forward data indicative of the increase in the speaker's heart rate, increase in the speaker's skin conductivity, increase in the speaker's blood pressure, increase/decrease in the speaker's body temperature, increase/decrease in the speaker's respiration rate, and/or increase/decrease in the speaker's respiration volume to the presenter feedback circuitry 116.

In embodiments, an occurrence of at least one of an audio presentation event 450, a video presentation event 460, and a biometric presentation event 470 may cause the presentation analysis circuitry 114 to analyze the received audio data 410, video data 420, and biometric data 430. Analyzing the received audio, video, and biometric data in response to a presentation event permits the presentation analysis circuitry 114 to beneficially and advantageously detect relationships and/or correlations between the received audio, video, and biometric data and the event itself. For example, if a biometric presentation event 470 (e.g., increased heart rate, decreased skin conductivity) occurs contemporaneous with audio data 410 in which the speaker 130 asks the audience for questions, it may indicate the speaker is nervous or uncomfortable answering questions from the audience.

In another example, the presentation analysis circuitry 114 may determine the appropriateness of the speaker's facial expression using video data 420 upon detecting an occurrence of an audio presentation event 450, such as when the audio data 410 indicates a delivery of sad or solemn news to an audience. In such an instance, the presentation analysis circuitry 114 would detect a happy facial expression when conveying the sad or solemn audio information as a video presentation event 460. The presentation analysis circuitry 114 would forward the data indicative of the video presentation event 460 to the presenter feedback circuitry 116. The presentation analysis circuitry 114 would also forward data indicative of the detected audio data 410 and video data 420 used to detect the video presentation event 460. In another example, the presentation analysis circuitry 114 may use the received audio data 410 to determine the appropriateness of the speaker's words considering cultural mores or norms and/or the received video data 420 to determine the appropriateness of the speaker's physical actions considering cultural mores or norms.

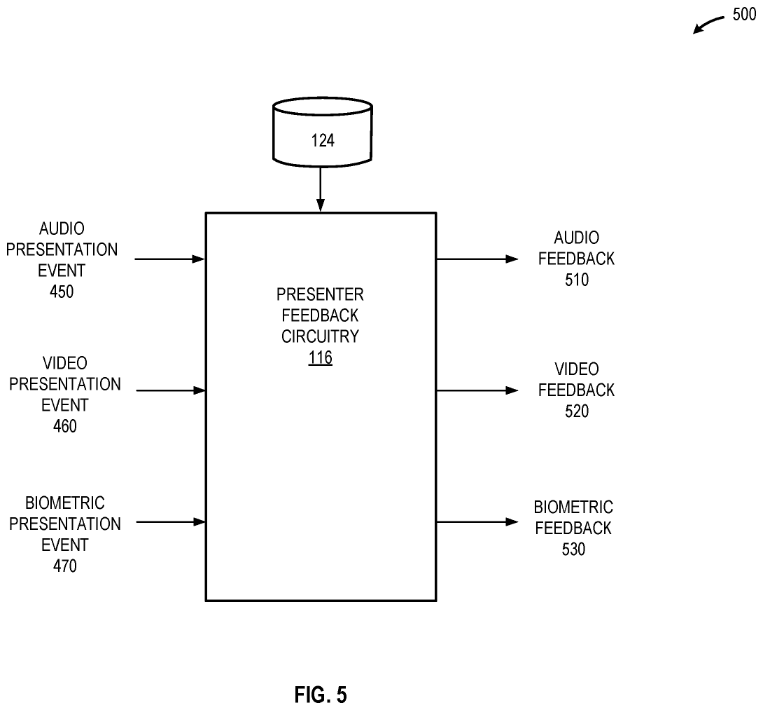

FIG. 5 is an input/output (I/O) diagram of illustrative presenter feedback circuitry 116, in accordance with at least one embodiment described herein. The presenter feedback circuitry 116 may receive data indicative of one or more: audio presentation events 450; video presentation events 460; and/or biometric presentation events 470 from the presentation analysis circuitry 114. In embodiments, the presenter feedback circuitry 116 analyzes the received audio, video, and/or biometric presentation event data to generate one or more outputs, including at least one of: an audio feedback output 510, a video feedback output 520, and/or a biometric feedback output 530. The presenter feedback circuitry 116 retrieves relevant audio feedback 510, video feedback 520, and/or biometric feedback 530 from one or more data stores, data structures, or databases stored or otherwise retained on one or more storage devices 124. In some implementations, the feedback may be delivered via one or more output devices 108 and/or via one or more wearable output devices 109. In some implementations, the presenter feedback circuitry 116 may include one or more input devices such as one or more keyboards, pointing devices, audio input devices, haptic input devices or similar that permit the speaker 130 to obtain additional presentation-related feedback from the presenter feedback circuitry 116.

In embodiments, the presenter feedback circuitry 116 may select audio, visual, and/or biometric feedback to strengthen or otherwise fortify existing presentation strengths and to correct or otherwise mitigate the effect of existing presentation weaknesses. In embodiments, the feedback provided by the presenter feedback circuitry 116 may be selected based upon cultural norms or mores of the expected audience of the presentation. Such feedback may be a part or portion of an “expert” or similar system that is periodically, intermittently, or continuously updated to reflect current trends and technological developments. Such feedback may be tailored (i.e., contain audio, video, and biometric data relevant) to a technical field, technology, audience education level, or similar. Such feedback may be populated with audio, video, and biometric data selected based upon the expected sophistication and/or knowledge of the proposed audience (e.g., high school, undergraduate, graduate educated). Such feedback may include a language that is not native to the speaker 130 and may assist the speaker in forming the proper grammar and diction to provide the presentation in a non-native foreign language.

In some implementations, the presenter feedback circuitry 116 may provide audio feedback via one or more audio output devices, such as one or more speakers one or more ear pieces, or similar. The presenter feedback circuitry 116 may provide video feedback to the speaker 130 via one or more display devices. In at least some implementations, the presenter feedback circuitry 116 may generate an avatar representing the speaker 130 to provide feedback posture, movement, gesture, and/or facial expression feedback information to the speaker 130. In some implementations, the presenter feedback circuitry 116 may provide haptic feedback to the speaker 130 via one or more devices worn by the speaker 130.

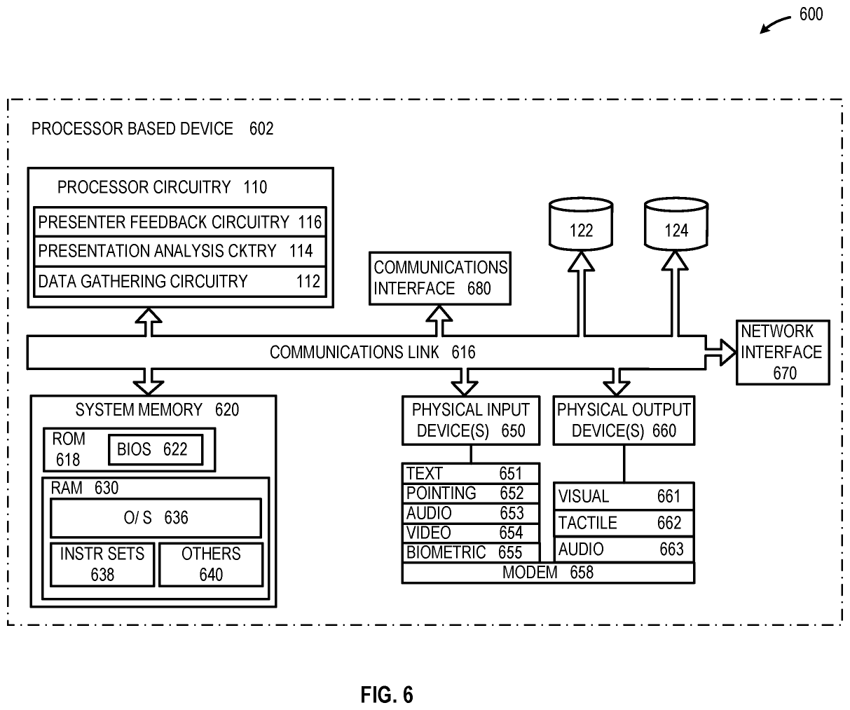

FIG. 6 is a block diagram of an illustrative system 600 that includes an illustrative processor-based device 602 capable of implementing the speech coaching systems and methods described herein, in accordance with at least one embodiment described herein. The following discussion provides a brief, general description of the components forming the illustrative processor-based device 602 capable of implementing the speech coaching system to collect audio, video and/or biometric information and provide feedback to improve the ability of a speaker 130 to deliver a presentation.

The processor-based device 602 includes processor circuitry 110 capable of implementing, forming, or otherwise providing data gathering circuitry 112, presentation analysis circuitry 114, and presenter feedback circuitry 116 in which the various embodiments described herein can be implemented. Although not required, some portion of the embodiments will be described in the general context of machine-readable or computer-executable instruction sets, such as program application modules, objects, or macros being executed by the data gathering circuitry 112, presentation analysis circuitry 114, and/or the presenter feedback circuitry 116. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, the data gathering circuitry 112, presentation analysis circuitry 114, and/or presenter feedback circuitry 116 may be disposed in both local and remote devices.

The processor circuitry 110, the data gathering circuitry 112, the presentation analysis circuitry 114, and/or the presenter feedback circuitry 116 may include any number of hardwired or configurable circuits, some or all of which may include programmable and/or configurable combinations of electronic components, semiconductor devices, and/or logic elements that are disposed partially or wholly in a PC, server, or other computing system capable of executing machine-readable instructions. The processor-based device 602 may include the processor circuitry 110, and may, at times, include a bus or similar communications link 616 that communicably couples and facilitates the exchange of information and/or data between various system components including a system memory 620 and the processor circuitry 110. The processor-based device 602 may be referred to in the singular herein, but this is not intended to limit the embodiments to a single device and/or system, since in certain embodiments, there will be more than one processor-based device 602 that incorporates, includes, or contains any number of communicably coupled, collocated, or remote networked circuits or devices.

The processor circuitry 110 may include any number, type, or combination of devices. At times, the processor circuitry 110 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), field programmable gate arrays (FPGAs), and the like. Unless described otherwise, the construction and operation of the various blocks shown in FIG. 6 are of conventional design. Consequently, such blocks need not be described in further detail herein, as they will be understood by those skilled in the relevant art. The communications link 616 that interconnects at least some of the components of the processor-based device 602 may employ any known serial or parallel bus structures or architectures.

The system memory 620 may include read-only memory (“ROM”) 618 and random access memory (“RAM”) 630. A portion of the ROM 618 may be used to store or otherwise retain a basic input/output system (“BIOS”) 622. The BIOS 622 provides basic functionality to the processor-based device 602, for example by causing the processor circuitry 110 to load one or more machine-readable instruction sets. In embodiments, at least some of the one or more machine-readable instruction sets cause at least a portion of the processor circuitry 110 to provide, create, produce, transition, and/or function as a dedicated, specific, and particular machine, such as the data gathering circuitry 112, the presentation analysis circuitry 114, and the presenter feedback circuitry 116.

The processor-based device 602 may include one or more communicably coupled, non-transitory, data storage devices 122, 124. Although depicted in FIG. 6 as disposed internal to the processor-based device 602, the one or more data storage devices 122, 124 may be disposed local to or remote from the processor-based device 602. The one or more data storage devices 122, 124 may include any current or future developed storage appliances, networks, and/or devices. Non-limiting examples of such data storage devices 122, 124 may include, but are not limited to, any current or future developed non-transitory storage appliances or devices, such as one or more magnetic storage devices, one or more optical storage devices, one or more solid-state electromagnetic storage devices, one or more electro-resistive storage devices, one or more molecular storage devices, one or more quantum storage devices, or various combinations thereof. In some implementations, the one or more data storage devices 122,124 may include one or more removable storage devices, such as one or more flash drives, flash memories, flash storage units, or similar appliances or devices capable of communicable coupling to and decoupling from the processor-based device 602.

The one or more data storage devices 122, 124 may include interfaces or controllers (not shown) communicatively coupling the respective storage device or system to the communications link 616. The one or more data storage devices 122, 124 may contain machine-readable instruction sets, data structures, program modules, data stores, databases, logical structures, and/or other data useful to the processor circuitry 110, the data gathering circuitry 112, the presentation analysis circuitry 114, and/or the presenter feedback circuitry 116. In some instances, one or more data storage devices 122, 124 may be communicably coupled to the processor circuitry 110, for example via communications link 616 or via one or more wired communications interfaces (e.g., Universal Serial Bus or USB); one or more wireless communications interfaces (e.g., Bluetooth®, Near Field Communication or NFC); one or more wired network interfaces (e.g., IEEE 802.3 or Ethernet); and/or one or more wireless network interfaces (e.g., IEEE 802.11 or WiFi®).

Machine-readable instruction sets 638 and other modules 640 may be stored in whole or in part in the system memory 620. Such instruction sets 638 may be transferred, in whole or in part, from the one or more data storage devices 122, 124. The instruction sets 338 may be loaded, stored, or otherwise retained in system memory 620, in whole or in part, during execution by the processor circuitry 110. The machine-readable instruction sets 638 may include machine-readable and/or processor-readable code, instructions, or similar logic capable of providing the speech coaching functions and capabilities described herein.

For example, the one or more machine-readable instruction sets 638 may cause the data gathering circuitry 112 to obtain speaker audio data 410, speaker video data 420, and/or speaker biometric data 430. The audio, video, and biometric data may be obtained on a continuous, intermittent, periodic, or aperiodic basis. At least a portion of the collected audio, video, and biometric data may be forwarded to the presentation analysis circuitry 114. At least a portion of the collected audio, video, and biometric data may be forwarded to the one or more storage devices 122.

The one or more machine-readable instruction sets 638 may cause the presentation analysis circuitry 114 to analyze the speaker audio data 410, speaker video data 420, and/or speaker biometric data 430 received from the data gathering circuitry 112. In some implementations, the one or more machine-readable instruction sets 638 may cause the presentation analysis circuitry 114 to compare various portions or segments of the received audio, video, and/or biometric data to detect a repetitive audio presentation event 450; a repetitive video presentation event 460; and/or a repetitive presentation event 470. In some implementations, the one or more machine-readable instruction sets 638 may cause the presentation analysis circuitry 114 to compare various portions or segments of the received audio, video, and/or biometric data to audio data, video data, and/or biometric data saved in one or more data stores, data structures or databases stored or otherwise retained on the one or more storage devices 122. Upon detecting one or more audio, video, and/or biometric presentation events, the one or more machine-readable instruction sets 638 may cause the presentation analysis circuitry 114 to communicate data indicative of an audio presentation event 450, a video presentation event 460, and/or a biometric presentation event 470 to the presenter feedback circuitry 116.

The one or more machine-readable instruction sets 638 may cause the presenter feedback circuitry 116 to provide audio feedback 510, video feedback 520, and/or biometric feedback 530 to the speaker 130. In some implementations, the presenter feedback circuitry 116 receives the data indicative of the audio presentation event 450, the video presentation event 460, and/or the biometric presentation event 470 from the presentation analysis circuitry 114 and selects appropriate feedback from one or more data stores, data structures, or databases stored or otherwise retained on the one or more storage devices 124. In some implementations, the one or more machine-readable instruction sets 638 may cause the presenter feedback circuitry 116 to generate and deliver audio, video, and/or biometric feedback using one or more avatars representative of the speaker 130.

A speech coaching system user may provide, enter, or otherwise supply commands (e.g., acknowledgements, selections, confirmations, and similar) as well as information and/or data (e.g., subject identification information, color parameters) to the processor-based device 602 using one or more communicably coupled input devices 650. The one or more communicably coupled input devices 650 may be disposed local to or remote from the processor-based device 602. At least some of the input devices 650 may be communicably coupled to the data gathering circuitry 112 and may include, but are not limited to, any number of: audio data acquisition or gathering devices; video data acquisition or gathering devices; or biometric data acquisition or gathering devices. The input devices 650 may include one or more: text entry devices 651 (e.g., keyboard); pointing devices 652 (e.g., mouse, trackball, touchscreen); audio input devices 653; video input devices 654; and/or biometric input devices 655 (e.g., fingerprint scanner, facial recognition, iris print scanner, voice recognition circuitry). In embodiments, at least some of the one or more input devices 650 may include a wired or a wireless communicable coupling to the processor-based device 602.

The speech coaching system user may receive output (e.g., feedback from the presenter feedback circuitry 116) from the processor-based device 602 via one or more output devices 660. In at least some implementations, the one or more output devices 660 may include, but are not limited to, one or more: visual output or display devices 661; tactile output devices 662; audio output devices 663, or combinations thereof. In embodiments, at least some of the one or more output devices 660 may include a wired or a wireless communicable coupling to the processor-based device 602.

For convenience, a network interface 670, the processor circuitry 110, the system memory 620, the one or more input devices 650 and the one or more output devices 660 are illustrated as communicatively coupled to each other via the communications link 616, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In some embodiments, all or a portion of the communications link 616 may be omitted and the components are coupled directly to each other using suitable wired or wireless connections.

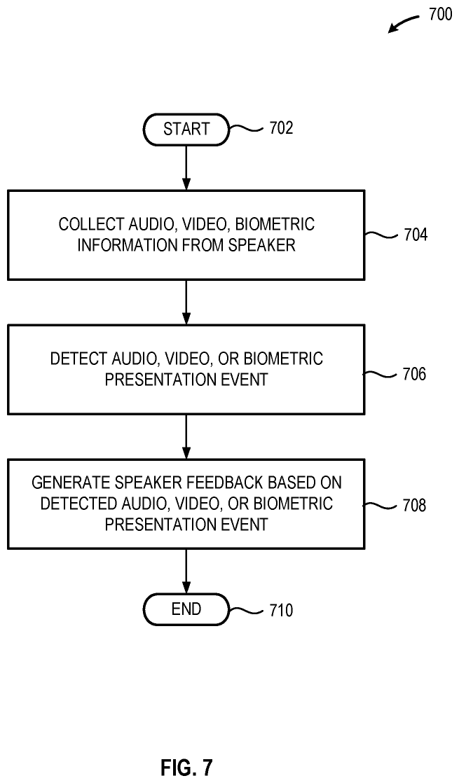

FIG. 7 is a high-level flow diagram of an illustrative speech coaching method 700, in accordance with at least one embodiment described herein. The method 700 commences at 702.

At 704, data gathering circuitry 112 collects at least one of: audio data, video data, or biometric data. The data gathering circuitry 112 collects the audio, video, and/or biometric data during a presentation by a speaker 130. In some implementations, the audio, video, and/or biometric data may be collected continuously, intermittently, periodically, or aperiodically. In some implementations, the data gathering circuitry 112 may store at least a portion of the collected audio, video, and/or biometric data on one or more storage devices 122.

At 706, the presentation analysis circuitry 114 detects an occurrence during the presentation by the speaker of at least one of: a defined audio event; a defined video event; or a defined biometric event. In some implementations, the presentation analysis circuitry 114 may detect the defined audio, video, or biometric event by comparing portions, segments, or sections of the collected audio data, video data, or biometric data to detect repeating patterns in the collected audio data, video data, or biometric data. In some implementations, the presentation analysis circuitry 114 may detect the defined audio, video, or biometric event by comparing portions, segments, or sections of the collected audio data, video data, or biometric data to defined audio, video, or biometric event stored on the one or more storage devices 122.

At 708, the presenter feedback circuitry 116 provides feedback to the speaker 130 based at least in part on the audio, video, or biometric event(s) detected in the presentation provided by the speaker 130. In at least some implementations, the presenter feedback circuitry 116 may generate feedback using one or more data stores, data structures, or databases stored or otherwise retained on one or more storage devices 124. The method 700 concludes at 710.

While FIG. 7 illustrates various operations according to one or more embodiments, it is to be understood that not all of the operations depicted in FIG. 7 are necessary for other embodiments. Indeed, it is fully contemplated herein that in other embodiments of the present disclosure, the operations depicted in FIG. 7 and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods for providing a speech coaching to a speaker. The system may include data gathering circuitry to collect audio, video, and biometric data generated by a speaker during a presentation. All or a portion of the collected audio, video, and biometric data may be stored or otherwise retained on one or more storage devices. All or a portion of the collected audio, video, and biometric data may be forwarded to the presentation analysis circuitry. The presentation analysis circuitry detects at least one of: an audio presentation event; a video presentation event; or a biometric presentation event based at least in part on the collected audio, video, and biometric data received from the data gathering circuitry. The detected audio presentation event; a video presentation event; or a biometric presentation event may be beneficial or detrimental to the effectiveness of the speaker's presentation. The presentation analysis circuitry forwards the detected audio presentation event; a video presentation event; or a biometric presentation event to the presenter feedback circuitry. The presenter feedback circuitry generates feedback for presentation to the speaker. The feedback provided by the presenter feedback circuitry may reinforce positive aspects of the speaker's presentation and provide corrective suggestions for the negative aspects of the speaker's presentation.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for providing an autonomous public speaking coaching system.

According to example 1, there is provided a public speaking coaching system. The system may include: processor circuitry; and at least one storage device that includes processor-readable instructions that, when executed by the processor circuitry, cause the processor circuitry to provide: data gathering circuitry to collect, during a presentation by a speaker, at least one of: audio data; video data; or biometric data; presentation analysis circuitry to detect an occurrence during the presentation by the speaker of at least one of: a defined audio event; a defined video event; or a defined biometric event; and presenter feedback circuitry to selectively provide feedback to the speaker, the feedback selected based upon at least one of: the defined audio event; the defined video event; or the defined biometric event.

Example 2 may include elements of example 1 where the instructions may further cause the data gathering circuitry to store on at least one communicably coupled data storage device at least a portion of at least one of: the collected audio data; the collected video data; or the collected biometric data.

Example 3 may include elements of example 1 where the instructions may further cause the presentation analysis circuitry to detect the occurrence of the defined audio event by comparing a tone of the collected audio data with data representative of a presentation setting to determine a suitability of the speaker's audio presentation for the presentation setting.

Example 4 may include elements of example 1 where the instructions may further cause the presentation analysis circuitry to detect the occurrence of the defined audio event using the collected audio data by comparing the collected audio data to one or more libraries containing stored audio event data.

Example 5 may include elements of example 4 where the presentation analysis circuitry may detect a defined audio event comprising a repetitive pattern in the collected audio data.

Example 6 may include elements of example 4 where the presentation analysis circuitry may detect a defined audio event comprising a change in audio volume output in the collected audio data.

Example 7 may include elements of example 1 where the presentation analysis circuitry may detect a defined video event by comparing a physical activity of the speaker with a presentation setting to determine a suitability of the physical activity for the presentation setting.

Example 8 may include elements of example 1 where the presentation analysis circuitry may detect a defined video event by comparing a physical activity of the speaker with defined mores of a culture to determine a suitability of the physical activity for the culture.

Example 9 may include elements of example 1 where the data gathering circuitry may further include at least one of: an audio data collection system; a video data collection system; or a biometric data collection system.

Example 10 may include elements of example 9 where the video data collection system may include one or more of: a facial expression gathering system, a gesture detection system, a body movement detection system, and an eye movement detection system.

Example 11 may include elements of example 1 where the presenter feedback circuitry may further include at least one wearable processor-based device to provide the corrective output to the presenter.

According to example 12, there is provided a public speaking coaching method. The method may include: collecting, by data gathering circuitry during a presentation by a speaker, at least one of: audio data; video data; or biometric data; detecting, by presentation analysis circuitry, an occurrence during the presentation by the speaker of at least one of: a defined audio event; a defined video event; or a defined biometric event; and selectively providing, by presenter feedback circuitry, feedback to the speaker, the feedback selected based upon at least one of: the defined audio event; the defined video event; or the defined biometric event.

Example 13 may include elements of example 12, and the method may additionally include storing, by the data gathering circuitry on at least one communicably coupled data storage device, at least a portion of at least one of: the collected audio data; the collected video data; or the collected biometric data.

Example 14 may include elements of example 12 where detecting an occurrence during the presentation by the speaker of a defined audio event may include comparing, by the presentation analysis circuitry, data indicative of a tone included in the audio data with data indicative of a presentation setting to determine a suitability of the speaker's audio presentation for the presentation setting.

Example 15 may include elements of example 12 where detecting an occurrence during the presentation by the speaker of a defined audio event may include detecting, by the presentation analysis circuitry, a pattern in the audio data indicative of a defined audio event.

Example 16 may include elements of example 15 where detecting a pattern in the audio data indicative of a defined audio event may include detecting, by the presentation analysis circuitry, a repeating pattern in the audio data, the repeating pattern indicative of a defined audio event.

Example 17 may include elements of example 15 where detecting a pattern in the audio data indicative of a defined audio event may include detecting, by the presentation analysis circuitry, audio data indicative of a change in presenter audio output volume.

Example 18 may include elements of example 12 where detecting an occurrence during the presentation by the speaker of a defined video event may include detecting, by the presentation analysis circuitry, a defined video event by comparing a physical activity of the speaker with a presentation setting to determine a suitability of the physical activity for the presentation setting.

Example 19 may include elements of example 12 where detecting an occurrence during the presentation by the speaker of a defined video event may include detecting, by the presentation analysis circuitry, a defined video event by comparing a physical activity of the speaker with defined mores of a culture to determine a compatibility of the physical activity with the cultural mores.

Example 20 may include elements of example 12 where collecting audio data may include collecting an audio data stream generated by the speaker during the presentation using an audio input system communicably coupled to the data gathering circuitry.

Example 21 may include elements of example 12 where collecting video data may include collecting video data that includes at least one of: a facial expression gathering system, a gesture detection system, a body movement detection system, and an eye movement detection system.

Example 22 may include elements of example 12 where selectively providing feedback to the speaker may include selectively providing, via the presenter feedback circuitry, feedback to the speaker using at least one wearable processor-based device.

According to example 23, there is provided a non-transitory computer readable medium that includes instructions that when executed by processor circuitry, cause the processor circuitry to provide data gathering circuitry, presentation analysis circuitry, and presenter feedback circuitry. The processor circuitry to: collect, by the data gathering circuitry during a presentation by a speaker, at least one of: audio data; video data; or biometric data; detect, by the presentation analysis circuitry, an occurrence during the presentation by the speaker of at least one of: a defined audio event; a defined video event; or a defined biometric event; and selectively provide, by the presenter feedback circuitry, feedback to the speaker, the feedback selected based upon at least one of: the defined audio event; the defined video event; or the defined biometric event.

Example 24 may include elements of example 23 where the instructions may further cause the data gathering circuitry to store, on at least one communicably coupled data storage device, at least a portion of at least one of: the collected audio data; the collected video data; or the collected biometric data.

Example 25 may include elements of example 23 where the instructions that cause the presentation analysis circuitry to detect an occurrence during the presentation by the speaker of a defined audio event, may further cause the presentation analysis circuitry to compare data indicative of a tone included in the audio data with data indicative of a presentation setting to determine a suitability of the speaker's audio presentation for the presentation setting.

Example 26 may include elements of example 23 where the instructions that cause the presentation analysis circuitry to detect an occurrence during the presentation by the speaker of a defined audio event may further cause the presentation analysis circuitry to detect a pattern in the audio data indicative of a defined audio event.

Example 27 may include elements of example 26 where the instructions that cause the presentation analysis circuitry to detect a pattern in the audio data indicative of a defined audio event may further cause the presentation analysis circuitry to detect, by the presentation analysis circuitry, a repeating pattern in the audio data, the repeating pattern indicative of the defined audio event.

Example 28 may include elements of example 23 where the instructions that cause the presentation analysis circuitry to detect an occurrence during the presentation by the speaker of a defined audio event may further cause the presentation analysis circuitry to detect, by the presentation analysis circuitry, audio data indicative of a change in presenter audio output volume.

Example 29 may include elements of example 23 where the instructions that cause the presentation analysis circuitry to detect an occurrence during the presentation by the speaker of a defined video event may further cause the presentation analysis circuitry to compare, by the presentation analysis circuitry, a physical activity of the speaker with a presentation setting to determine a suitability of the physical activity for the presentation setting.

Example 30 may include elements of example 23 where the instructions that cause the presentation analysis circuitry to detect an occurrence during the presentation by the speaker of a defined video event may further cause the presentation analysis circuitry to compare, by the presentation analysis circuitry, a physical activity of the speaker with defined mores of a culture to determine a compatibility of the physical activity with the cultural mores.

Example 31 may include elements of example 23 where the instructions that cause the data gathering circuitry to collect audio data may further cause the data gathering circuitry to collect, via a communicably coupled audio input system, the audio data stream generated by the speaker during the presentation.

Example 32 may include elements of example 23 where the instructions that cause the data gathering circuitry to collect video data may further cause the data gathering circuitry to collect, via a video data collection system communicably coupled to the data gathering circuitry, video data that includes at least one of: a facial expression gathering system, a gesture detection system, a body movement detection system, and an eye movement detection system.

Example 33 may include elements of example 23 where the instructions that cause the presenter feedback circuitry to selectively provide feedback to the speaker may further cause the presenter feedback circuitry to selectively provide feedback to the speaker using at least one communicably coupled wearable processor-based device.

According to example 34, there is provided a public speaking coaching system. The system may include: means for collecting at least one of: audio data; video data; or biometric data; means for detecting an occurrence during the presentation by the speaker of at least one of: a defined audio event; a defined video event; or a defined biometric event; and means for selectively providing feedback to the speaker, the feedback selected based upon at least one of: the defined audio event; the defined video event; or the defined biometric event.

Example 35 may include elements of example 34, and the system may additionally include: means for storing at least a portion of at least one of: the collected audio data; the collected video data; or the collected biometric data.

Example 36 may include elements of example 34 where the means for detecting an occurrence during the presentation by the speaker of a defined audio event may include means for comparing data indicative of a tone included in the audio data with data indicative of a presentation setting to determine a suitability of the speaker's audio presentation for the presentation setting.

Example 37 may include elements of example 34 where the means for detecting an occurrence during the presentation by the speaker of a defined audio event may include means for detecting a pattern in the audio data indicative of a defined audio event.

Example 38 may include elements of example 37 where the means for detecting a pattern in the audio data indicative of a defined audio event may include means for detecting a repeating pattern in the audio data, the repeating pattern indicative of a defined audio event.

Example 39 may include elements of example 37 where the means for detecting a pattern in the audio data indicative of a defined audio event may include means for detecting audio data indicative of a change in presenter audio output volume.

Example 40 may include elements of example 34 where the means for detecting an occurrence during the presentation by the speaker of a defined video event may include means for detecting a defined video event by comparing a physical activity of the speaker with a presentation setting to determine a suitability of the physical activity for the presentation setting.

Example 41 may include elements of example 34 where the means for detecting an occurrence during the presentation by the speaker of a defined video event may include means for detecting a defined video event by comparing a physical activity of the speaker with defined mores of a culture to determine a compatibility of the physical activity with the cultural mores.

According to example 42, there is provided a public speaking coaching system arranged to perform the method of any of examples 12 through 22.

According to example 43, there is provided a chipset arranged to perform the method of any of examples 12 through 22.

According to example 44, there is provided a non-transitory machine readable medium comprising a plurality of instructions that, in response to be being executed on a computing device, cause the computing device to carry out the method according to any of examples 12 through 22.

According to example 45, there is provided a public speaking coaching system, the device being arranged to perform the method of any of examples 12 through 22.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A public speaking coaching system, comprising:
processor circuitry; and
at least one storage device that includes processor-readable instructions that, when executed by the processor circuitry, cause the processor circuitry to provide:
data gathering circuitry to collect, during a presentation by a speaker, at least one of: audio data; video data; or biometric data;
presentation analysis circuitry to detect an occurrence during the presentation by the speaker of at least one of: a defined audio event; a defined video event; or a defined biometric event;
presenter feedback circuitry to selectively provide feedback to the speaker, the feedback selected based upon at least one of: the defined audio event; the defined video event; or the defined biometric event.

2. The method of claim 1 wherein the instructions further cause the data gathering circuitry to store on at least one communicably coupled data storage device at least a portion of at least one of: the collected audio data; the collected video data; or the collected biometric data.

3. The system of claim 1 wherein the instructions further cause the presentation analysis circuitry to detect the occurrence of the defined audio event by comparing a tone of the collected audio data with data representative of a presentation setting to determine a suitability of the speaker's audio presentation for the presentation setting.

4. The system of claim 1 wherein the instructions further cause the presentation analysis circuitry to detect the occurrence of the defined audio event using the collected audio data by comparing the collected audio data to one or more libraries containing stored audio event data.

5. The system of claim 4 wherein the presentation analysis circuitry detects a defined audio event comprising a repetitive pattern in the collected audio data.

6. The system of claim 4 wherein the presentation analysis circuitry detects a defined audio event comprising a change in audio volume output in the collected audio data.

7. The system of claim 1 wherein the presentation analysis circuitry detects a defined video event by comparing a physical activity of the speaker with a presentation setting to determine a suitability of the physical activity for the presentation setting.

8. The system of claim 1 wherein the presentation analysis circuitry detects a defined video event by comparing a physical activity of the speaker with defined mores of a culture to determine a suitability of the physical activity for the culture.

9. The system of claim 1 wherein the data gathering circuitry further comprises at least one of: an audio data collection system; a video data collection system; or a biometric data collection system.

10. The system of claim 9 wherein the video data collection system comprises one or more of: a facial expression gathering system, a gesture detection system, a body movement detection system, and an eye movement detection system.

11. The system of claim 1 wherein the presenter feedback circuitry further comprises at least one wearable processor-based device to provide the corrective output to the presenter.

12. A public speaking coaching method, comprising:
collecting, by data gathering circuitry during a presentation by a speaker, at least one of: audio data; video data; or biometric data;
detecting, by presentation analysis circuitry, an occurrence during the presentation by the speaker of at least one of: a defined audio event; a defined video event; or a defined biometric event; and
selectively providing, by presenter feedback circuitry, feedback to the speaker, the feedback selected based upon at least one of: the defined audio event; the defined video event; or the defined biometric event.

13. The public speaking coaching method of claim 12, further comprising:
storing, by the data gathering circuitry on at least one communicably coupled data storage device, at least a portion of at least one of: the collected audio data; the collected video data; or the collected biometric data.

14. The method of claim 12 wherein detecting an occurrence during the presentation by the speaker of a defined audio event comprises:
comparing, by the presentation analysis circuitry, data indicative of a tone included in the audio data with data indicative of a presentation setting to determine a suitability of the speaker's audio presentation for the presentation setting.

15. The method of claim 12 wherein detecting an occurrence during the presentation by the speaker of a defined audio event comprises:
detecting, by the presentation analysis circuitry, a pattern in the audio data indicative of a defined audio event.

16. The method of claim 15 wherein detecting a pattern in the audio data indicative of a defined audio event comprises:
detecting, by the presentation analysis circuitry, a repeating pattern in the audio data, the repeating pattern indicative of a defined audio event.

17. The method of claim 15 wherein detecting a pattern in the audio data indicative of a defined audio event comprises:
detecting, by the presentation analysis circuitry, audio data indicative of a change in presenter audio output volume.

18. The method of claim 12 wherein detecting an occurrence during the presentation by the speaker of a defined video event comprises:
detecting, by the presentation analysis circuitry, a defined video event by comparing a physical activity of the speaker with a presentation setting to determine a suitability of the physical activity for the presentation setting.

19. The method of claim 12 wherein detecting an occurrence during the presentation by the speaker of a defined video event comprises:
detecting, by the presentation analysis circuitry, a defined video event by comparing a physical activity of the speaker with defined mores of a culture to determine a compatibility of the physical activity with the cultural mores.

20. The method of claim 12 wherein collecting audio data comprises:
collecting an audio data stream generated by the speaker during the presentation using an audio input system communicably coupled to the data gathering circuitry.

21. The method of claim 12 wherein collecting video data comprises:
collecting video data that includes at least one of: a facial expression gathering system, a gesture detection system, a body movement detection system, and an eye movement detection system.

22. The method of claim 12 wherein selectively providing feedback to the speaker comprises:
selectively providing, via the presenter feedback circuitry, feedback to the speaker using at least one wearable processor-based device.

23. A non-transitory computer readable medium that includes instructions that when executed by processor circuitry, cause the processor circuitry to provide data gathering circuitry, presentation analysis circuitry, and presenter feedback circuitry to:
collect, by the data gathering circuitry during a presentation by a speaker, at least one of: audio data; video data; or biometric data;
detect, by the presentation analysis circuitry, an occurrence during the presentation by the speaker of at least one of: a defined audio event; a defined video event; or a defined biometric event; and
selectively provide, by the presenter feedback circuitry, feedback to the speaker, the feedback selected based upon at least one of: the defined audio event; the defined video event; or the defined biometric event.

24. The non-transitory computer readable medium of claim 23 wherein the instructions further cause the data gathering circuitry to:
store, on at least one communicably coupled data storage device, at least a portion of at least one of: the collected audio data; the collected video data; or the collected biometric data.

25. The non-transitory computer readable medium of claim 23, the instructions that cause the presentation analysis circuitry to detect an occurrence during the presentation by the speaker of a defined audio event, further cause the presentation analysis circuitry to:
compare data indicative of a tone included in the audio data with data indicative of a presentation setting to determine a suitability of the speaker's audio presentation for the presentation setting.
